(19) United States
(12) Patent Application Publication
(10) Pub. No.: US 2024/0073017 A1
(43) Pub. Date: Feb. 29, 2024

(54) Methods, Devices, and Systems of Using Blockchain to Track Proof-of-Viewing

(71) Applicant: Synamedia Limited, Staines Upon Thames (GB)

(72) Inventors: Avi Fruchter, Neve Daniel (IL); Jonathan Abram Segal, Efrat (IL); Bayla Hirsch, Jerusalem (IL); Benjamin Thomas Samways, Dorset (GB); Ariel Luwisch, Alon Shvut (IL); Mercedes Jenifer Bouhsira, Givat Zeev (IL)

(21) Appl. No.: 17/897,027

(22) Filed: Aug. 26, 2022

(51) Int. Cl. H04L 9/14; H04L 9/00; H04L 9/08

(52) U.S. Cl. CPC H04L 9/14; H04L 9/0869; H04L 9/50

(57) ABSTRACT

Techniques for proof-of-viewing (POV) are described herein. In accordance with various embodiments, server(s) used by parties interested in tracking POV register media content items in a blockchain, receive a request to view a media content item of the media content items from a client, generate an intent object indicating the request to view the media content item by the client, and record the intent object in the blockchain. A server for reporting POV receives, from the client, a request for at least a portion of a media content item, where the intent object is embedded in the request, sends at least the portion of the media content item to the client and reports to the blockchain to cause the blockchain to record the intent object and an intent state in the blockchain based on sending at least the portion of the media content item to the client.

### TECHNICAL FIELD

The present disclosure relates generally to media content delivery and, more specifically, to using blockchain to track media content views.

### BACKGROUND

Proof-of-Viewing (POV) is a metric valuable to many stakeholders in the media content industry. Parties, such as studios, content providers, service providers, consumers, advertisers, and market forecasters, have different yet sometimes shared interests in media content viewing activities. To track media content views, POV is often used for billing, reporting, advertising and business trends analytics, and forecasting. Currently, client-based POV reporting is widely used to monitor media content consumption. However, client-based POV reporting can be problematic, unreliable, or even dishonest. As such, intervention is often necessary for operating the client applications, and the reporting process requires constant optimization, securing, and hardening, thus driving up the cost. Relative to client-based POV reporting, server-based POV reporting has numerous advantages, the cloud infrastructure allows scalability on demand to ensure metrics gathering under stress and load. However, due to reasons such as competing interests, cost, and scalability issues, server-based POV reporting solutions are not widely used.

For example, service providers, studios, content providers, pirates, and end viewers have competing incentives to verify and track who has watched what. Many previously existing server-side POV solutions provided by service providers offer periodic reporting of views using each service provider's proprietary tracking technologies for tracking the number of views observed in their network. Such solutions require strong trust between the content providers and the service providers, which may not exist. Furthermore, the periodic reporting by the service providers cannot provide the viewing information to the content providers in real time. The lagging in reporting may prevent the content providers from making strategic and sophisticated business decisions in real-time, e.g., auction of advertisements or real-time pricing adjustments by the content providers.

In another example, tracking millions of views in the cloud during peak times can be costly and add constraints to the cloud infrastructure. In recent years, to distribute the load on the cloud infrastructure, attempts have been made to use blockchain technologies in the cloud for server-side POV reporting. However, many blockchain platforms have throughput limitations. As such, without optimization, many blockchain technologies cannot track simultaneous media content views on a large scale.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram of an exemplary media content view reporting, in accordance with some embodiments;

FIG. 2 is a diagram illustrating a process of registering an intent object for proof-of-viewing (POV), in accordance with some embodiments;

FIG. 3 is a block diagram illustrating a process of tracking an intent object for POV, in accordance with some embodiments;

FIGS. 4A-4C are diagrams illustrating using a pseudo random number generator (PRNG) value for reporting enforcement, in accordance with some embodiments;

FIGS. 5A and 5B are flow diagrams illustrating a method of generating and using an intent object for POV, in accordance with some embodiments;

FIGS. 6A and 6B are flow diagrams illustrating a method of using an intent object for POV reporting, in accordance with some embodiments;

FIG. 7 is a block diagram of a computing device for registering media content items in a blockchain and recording intent objects in the blockchain for POV reporting, in accordance with some embodiments; and

FIG. 8 is a block diagram of a computing device for using intent objects recorded in a blockchain for tracking POV reporting, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overview

Techniques disclosed herein provide trusted near-real-time accurate tracking of viewed media content and reduce the risk of having inaccurate viewing data. When a client requests to view a media content item, an intent to view structure is created in a blockchain database to record the view using an intent object. In some embodiments, a URL for the content is provided to the client, which includes the intent object. In some embodiments, the intent object is associated with an intent identifier (ID) that is created cryptographically to resist forgery. During playback, the intent ID is validated before the content is provided to the client, thus preventing unauthorized playback. In some embodiments, the intent object in the blockchain database is tracked when the manifest for the media content item and/or segments of the media content item are downloaded for proof-of-viewing (POV). Additionally, in some embodiments, the media content item is declared as being viewed in the blockchain database according to a smart contract that is agreed upon by various parties involved, e.g., between service provider(s) and content provider(s), or between viewers and reward vendors, etc. In some embodiments, the blockchain is configured such that each party has its customized view of the POV data, e.g., the service provider(s) have access to the data for their customers and the content provider(s) have access to summary data of started and completed views for their content. Accordingly, the POV data is securely tracked in the blockchain database and accessible in near-real-time by the parties, thus eliminating the potential for discrepancies between datasets.

In accordance with various embodiments, a method of generating and using an intent object for POV tracking is performed at one or more servers that include one or more processors, one or more non-transitory memory, and one or more network interfaces. The one or more servers register media content items in a blockchain. The one or more servers receive a request to view a media content item of the media content items from a client. In response to receiving the request, the one or more servers generate an intent object indicating the request to view the media content item by the client. The one or more servers then record the intent object in the blockchain.

In accordance with various embodiments, a method of using an intent object for POV reporting is performed at a device that includes a processor, a non-transitory memory, and a network interface. The device receives, from a client, a request for at least a portion of a media content item, where an intent object is embedded in the request. In response to receiving the request, the device sends at least the portion of the media content item to the client. The device also reports to a blockchain to cause the blockchain to record the intent object and an intent state associated with the intent object in the blockchain based on sending at least the portion of the media content item to the client.

### EXAMPLE EMBODIMENTS

As described above, parties involved in media content delivery may not be motivated to accurately report viewing data, e.g., under-reporting viewing of content to pay less for the content or over-reporting viewing of advertisements to collect more rewards. Currently, content owners have no way of independently validating the reported data and rely on parties such as service providers to generate periodic usage reports based on either the server provider's control plane data or client device data. Also as described above, it is impractical to use some blockchains with throughput limitations for tracking millions of simultaneous content views. The solution described herein addresses the aforementioned proof-of-viewing (POV) issues and provides trusted near-real-time accurate tracking of content.

The solution described herein in accordance with various embodiments provides a viewable URL from a control plane (e.g., a plane with server(s) for authentication and/or authorization) that is tagged with an intent identifier (ID) for an intent object, where the intent object represents a request to view a media content item. An enhanced data plane validates that the intent ID is valid before providing the media content item for authorization and tracks in a blockchain database for the intent when a manifest and segments associated with the media content item are downloaded in accordance with some embodiments. Because the blockchain allows data to be shared in near-real-time and the tracking is performed on the server-side in the data plane, there is no integration cost on the client side. Moreover, because the distributed and decentralized blockchain database is trusted by the parties and updated in real time, the risk of having inaccurate viewing data is reduced and no single entity is relied upon to maintain and provide tools for generating and accessing the POV data.

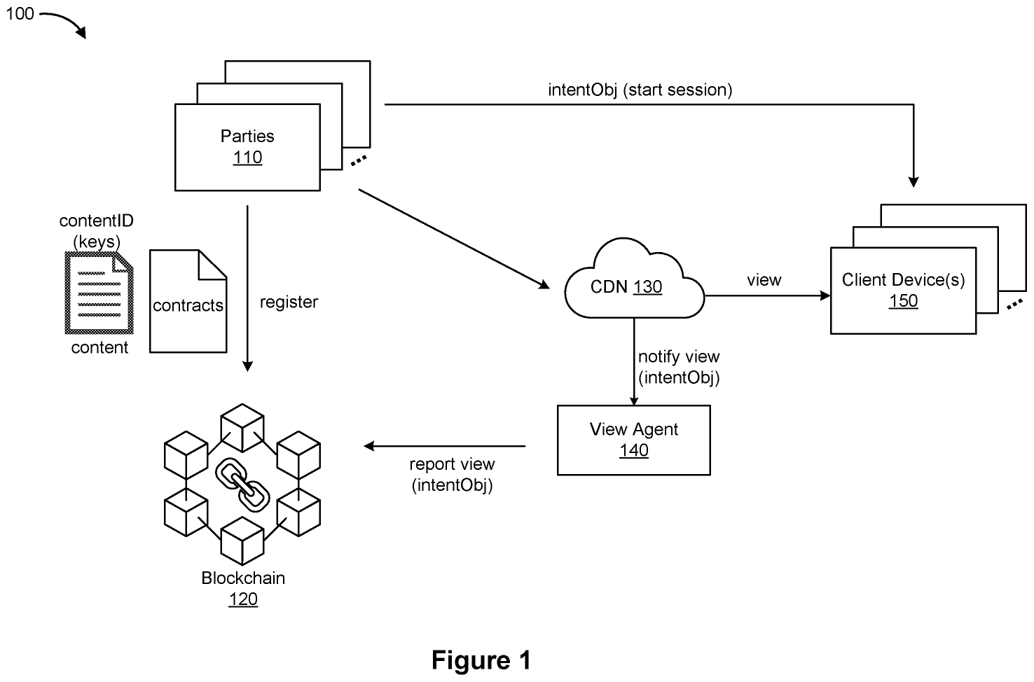

FIG. 1 is a block diagram illustrating an exemplary media content view reporting system 100 in accordance with some embodiments. In some embodiments, the exemplary media content view reporting system 100 includes a blockchain 120 configured such that parties 110 register media content items according to agreed contracts and have various access to media content view data in near-real-time, e.g., views of the registered media content items at a plurality of client devices 150. As used herein, a media content item includes any multimedia content, such as video, audio, and/or text. As such, the terms “multimedia content item”, “media content item”, “media content”, “content”, “multimedia asset”, “media asset”, and “asset” are used interchangeably hereinafter. Also as used herein, the terms “client device” and “client” are used interchangeably and refer to a device used by an end user and/or a user.

In some embodiments, the parties 110 include studios, content providers, service providers, consumers, advertisers, market forecasters, etc. that have different yet sometimes shared interests in POV. For example, content providers and service providers are parties 110 since the content providers are interested in underreporting of content consumption by consumers within a service provider's network and the payment from the service provider based on the content consumption data. In another example, consumers (e.g., as viewers of advertisements) and advertisers (e.g., as reward vendors) are the parties 110 since the advertisers are interested in the actual view of the advertisements when the consumers redeem viewing points or tokens.

In some embodiments, as shown in FIG. 1, the parties 110 register media content items in the blockchain 120 having an agreed-upon smart contract between them. In some embodiments, during the registration, a respective media content item identifier (ID) corresponding to a respective media content item registered in the blockchain 120 is encrypted using key(s) assigned to the part(ies) 110. For example, the parties 110 can be a content provider and service provider(s), where the content provider provides media content to multiple service providers and each of the service provider(s) provides the media content obtained from the content provider to clients in the service provider's network. During registration, the content provider and the service provider(s) register their content in the blockchain 120 according to the smart contract between them and encrypt the content ID of the content with keys of the content provider and the service provider(s). As a result of the encryption, each service provider has access to the content IDs that are associated with media content items provided to the clients in the service provider's network, and the content provider has access to the content IDs that are associated with the media content item provided by the content provider to multiple service providers in accordance with some embodiments.

In some embodiments, in addition to the blockchain 120, the exemplary media content view reporting system 100 also includes a content delivery network (CDN) 130 to facilitate media content delivery to a plurality of client devices 150. Though FIG. 1 shows using the CDN 130 to facilitate the content delivery, the CDN 130 can be any server for providing content, such as an edge server, a cache, an origin, etc. In some embodiments, the exemplary media content view reporting system 100 also includes a view agent 140 for reporting views of media content to the blockchain 120. When a respective client device 150 requests a media content item from the CDN 130, as will be described in further detail below, an intent object is registered with the blockchain 120 and tracked in the blockchain when the view agent 140 reports viewing activities of the media content item on the respective client device 150.

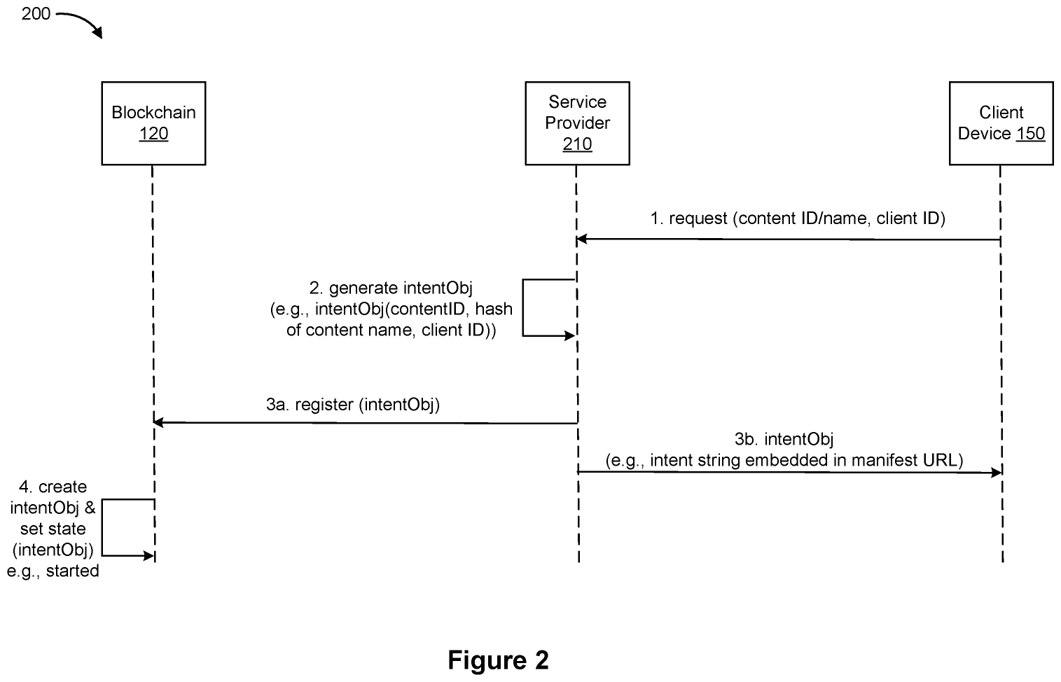

In particular, when a client at and via a respective client device 150 requests to view a media content item that has been registered with the blockchain 120, as will be described with reference to FIG. 2, one of the parties 110, e.g., a service provider, generates a unique intent object for the view of the media content item by the client and registers the unique intent object with the blockchain 120 in accordance with some embodiments. In some embodiments, a service provider, as one of the parties 110, obtains the intent object from a smart contract in the blockchain 120 and provides the intent object to the client device 150. In some embodiments, during playback, the intent object is created or reused when the media content item started to be played back at the respective client device 150. In such embodiments, the intent object is returned to the respective client device 150 by the content provider, which is also one of the parties 110 in accordance with various embodiments, and checked by the service provider to determine whether to reuse the intent object, e.g., based on parameters and/or properties of the intent object and/or agreements between the service provider and the content provider. In the case of the service provider determining not to reuse the intent object, in some embodiments, the service provider registers a new intent object in the blockchain 120.

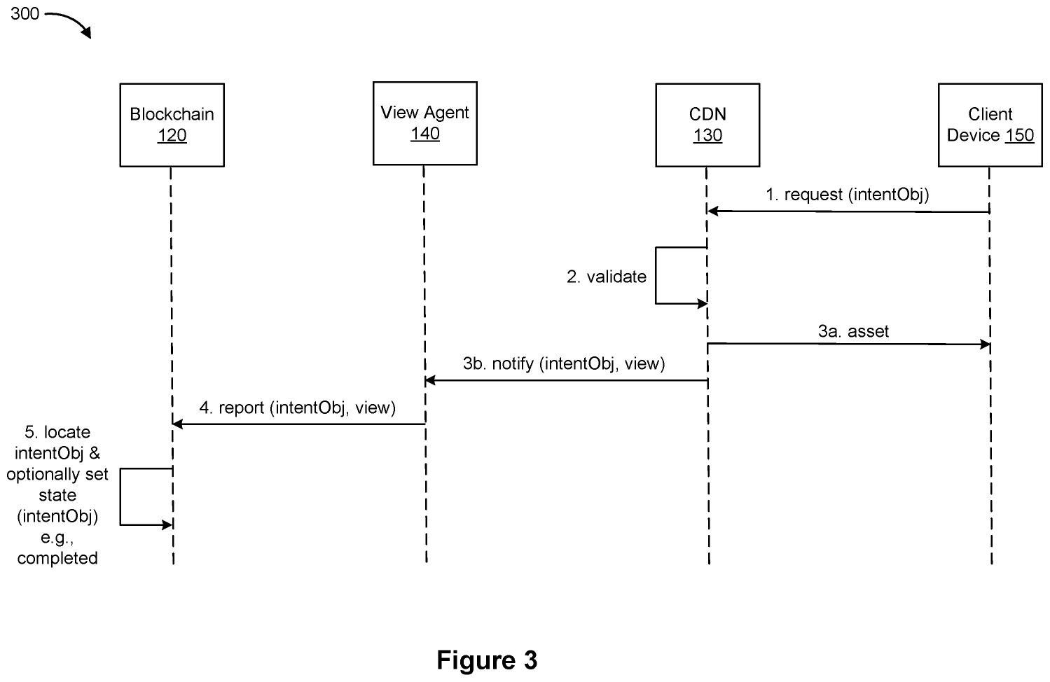

The intent object can be a string in accordance with some embodiments or any data type, such as a payload, blob, and/or token, etc. In some embodiments, the unique intent object is also sent to the respective client device 150, e.g., at the start of the viewing session directly from the part(ies) as shown in FIG. 1 or via the CDN 130 (not shown). The unique intent object is then used in subsequent requests for portions of the media content item. In some embodiments, as will be described with reference to FIG. 3 and as shown in FIG. 1, while providing the portions of the media content item for viewing to the client device 150, the CDN 130 notifies the view agent 140 of the viewing. The view agent 140 then reports the viewing to the blockchain 120, e.g., by sending the intent object to the blockchain 120, so that the intent object registered in the blockchain 120 can be tracked while the portions of the media content item are viewed.

In some embodiments, the smart contract(s) registered in the blockchain 120 also specify viewing conditions corresponding to viewing a portion of the media content item for an intent object being set in “completed” state in the blockchain database 120. As such, as will be described below with reference to FIGS. 2 and 3, the checks by the smart contracts allow portion(s) of actual downloaded segments to act as the POV, thereby reducing the number of transactions executed in the blockchain 120. In some embodiments, the smart contract(s) also determine whether the reporting time of the view of each segment is logical based on properties of the segment such as segment positions and/or durations. For example, the smart contract(s) can identify an anomaly in POV reporting when segment B is reported a few seconds after the reporting time of segment A while segment B is located multiple minutes after segment A along the presentation timeline of the media content item.

It should be noted that components are represented in the exemplary media content view reporting system 100 for illustrative purposes. Other configurations can be used and/or included in the exemplary system 100. For example, each of the parties 110 can have one or more servers for registering the content and/or the contracts as well as providing content, authentication, and/or authorization, etc. In another example, the CDN 130 and the view agent 140 can be integrated, e.g., on the one or more devices, or distinct, e.g., on separate devices that host distributed CDN servers and/or view agent(s). As such, various features of implementations described herein with reference to FIG. 1 can be embodied in a wide variety of forms, and that any specific structure and/or function described herein is illustrative.

FIG. 2 is a diagram illustrating a process 200 of registering an intent object for POV in accordance with some embodiments. In step 1 of the process 200, a client at the client device 150 requests to view a media content item. In some embodiments, a service provider 210 providing services to the client through a service provider network (e.g., one of the parties 110 in FIG. 1) receives the request, e.g., via the CDN 130 in FIG. 1, and generates a unique intent object in step 2. In some embodiments, the intent object includes a unique content ID corresponding to the registered media content item in the blockchain 120. In some embodiments, the intent object also includes an identifier of the client requesting the media content item, e.g., client ID(s) associated with the respective client device 150 and/or the user at the respective client device 150 as derived from the request. Additionally, in some embodiments, the intent object includes a hash of the content name requested to view as derived from the request. In some embodiments, instead of using the hash of the content name, other unique identifiers of the content can be in the intent object in place of or in combination with the hash of the content name.

In step 3a of the process 200, the service provider 210 registers the intent object with the blockchain 120 and in step 3b of the process 200, the service provider 210 also sends the intent object to the client device 150, e.g., directly as shown in FIG. 1 or via the CDN 130 to a video player on the client device 150. In some embodiments, when the intent object already exists in the blockchain 120, e.g., a continued view, the service provider 210 locates the intent object in step 3a, e.g., reusing the intent object, and returns the located intent object to the client device 150 in step 3b. In some embodiments, the intent object is encrypted and/or signed by the service provider 210 when being sent to the client device 150. In such embodiments, at playback, e.g., when the client device 150 passes back the intent object, the intent object can be validated, e.g., by the CDN and/or the smart contract to ensure the intent object was not manipulated and/or the identifiers in the intent objects match the identifier(s) in the request, etc.

In some embodiments, when sending the intent object to the client device 150 in step 3b, the intent object is sent as a string and embedded in the URL of the top-level manifest. In such embodiments, when the video player on the client device 150 starts to play the media content item, a request is made to the CDN using a unique intent URL, which includes the name of the media content item and the intent string. Also in such embodiments, the CDN can then validate the intent URL and the intent string before streaming the content to the client device 150.

In some embodiments, in step 4 of the process 200, the registration request from the service provider 210 triggers the blockchain 120 setting the state of the intent object. In some embodiments, the smart contract in the blockchain 120, with rights to access the intent object, sets the state of the intent object based on whether this is a first view of the media content item by the client, a continued view, or a repeated view. For a first or repeated view of the media content item, in some embodiments, the smart contract sets the state for the intent object as “started”. Though not shown in FIG. 2, in some embodiments, when the intent object already exists in the blockchain 120, e.g., a continued view, in response to the request received from step 1, the service provider 210 locates the intent object so that the state for the intent object can be updated.

As used herein, a first view indicates the first time a media asset is viewed by a client. For a first view, a new intent object is generated and the state for the invent object is set to “started” as described above. When a media asset is viewed again, depending on the agreement(s) between the parties, the viewing activity can be considered a continued view or a repeated view in accordance with various embodiments. In the case of a continued view, as described above, the intent object is reused; and in the case of a repeated view, a new intent object is created. For example, under a first agreement, when a media asset was not finished playing the first time, the original intent object can be reused in a continued view, so that the state can be updated to “completed” once the client finishes viewing the remaining portion of the media asset the second time. In another example, under a second agreement, any time any portion of a media asset is viewed, a new intent object is generated, and the state is set to “completed” when the client continuously plays the media asset to the finish. In still another example, under a third agreement, the intent object may have an expiration time property such that if more than a predefined duration (e.g., 24 hours) has passed from the creation of the intent object, a new intent object is generated when the same media asset is requested by the same client. In yet another example, under a fourth agreement, the same intent object is reused when a client repeatedly requests and plays the same media asset.

FIG. 3 is a diagram illustrating a process 300 of tracking an intent object for POV in accordance with some embodiments. In step 1 of the process 300, when the client device 150 (e.g., a video player on the client device 150) starts to play the media content item for the client to view, the client device 150 sends a request to the CDN 130 that includes the intent object, e.g., sending the unique intent URL with the name of the asset and the intent string. In some embodiments, in step 2 of the process 300, the CDN 130 validates the intent object and the request, e.g., by decrypting the intent string and checking the hash of the content name in the intent URL with the hash in the decrypted intent string. In some embodiments, when using other content identifier(s) in the intent object in place of the asset name, in step 3 of the process 300, the CDN 130 validates the intent object and the request by comparing the content identifier(s) in the intent string with content identifiers in the intent URL, including comparing the content identifier(s) in encrypted and/or encoded form(s). In some embodiments, in the case of successfully validating the intent object, in step 3a, the CDN 130 sends the content to the client device 150. Though not shown in FIG. 3, when the CDN 130 unsuccessfully validates the intent object, the CDN 130 does not report the view of the content and/or ceases to send the content to the client device 150. In some embodiments, sending the content includes sending a top-level manifest, a playlist manifest, and/or a media segment. Each of such objects associated with the content is addressed relative to the top-level manifest. As such, requests for the content from the client device 150 automatically include the manifest string, which further includes the intent object.

In addition to sending the intent object to the client device 150, upon successful validation of the intent object, the CDN 130 also sends the intent object to the view agent 140 via any type of message broker along with details of the viewing of the content in step 3b for asynchronous processing, e.g., sending the segment being viewed, the timestamp, the client ID requesting the content, and/or the content name, etc. along with the intent object. In some embodiments, the view agent 140 monitors the message and/or notification posted by the CDN 130 and reports the intent object and the viewing information to the blockchain 120 in step 4. In some embodiments, in response to receiving the report, in step 5, the blockchain 120 updates the blockchain with the status of the view.

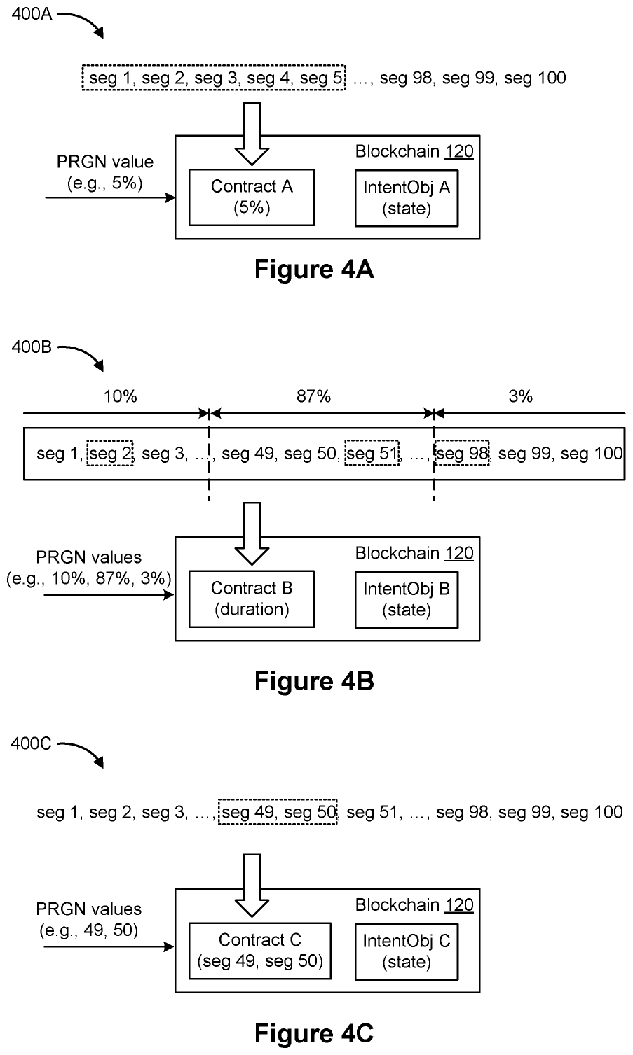

In some embodiments, to perform the update, the smart contract that has the right to access the intent object registered in the blockchain 120 updates the state of the intent object. In some embodiments, as described above with reference to FIG. 2, the state setting is dependent on whether the view is a first view, a continued view, or a repeat view of the asset by the client. For a continued view, because the intent object has been registered in the blockchain 120, the state of the intent object is updated based on the view information. For instance, the smart contract can proclaim a status to “completed” when the agreed-upon conditions specified in the smart contract have been met as will be described with reference to FIG. 4A-4C. In some embodiments, the smart contract validates the reported view prior to updating the state. For example, the smart contract can validate the reported view based on timestamps and/or durations, such as determining that the reporting time of view of each segment was logical based on the segment positions and/or durations. Other properties derived from the reported view can also be validated by the smart contract in accordance with various embodiments.

FIGS. 4A-4C are diagrams 400A-400C illustrating using a pseudo random number generator (PRNG) value for reporting enforcement in accordance with some embodiments. An issue associated with some existing blockchain implementations is the limitation of scaling, e.g., the limited amount of transactions the blockchain can handle in consideration of speed and cost. When tracking millions of concurrent viewing sessions, to reduce the load of transactions on the blockchain, a random set of segments is be reported and counted as POV in the system described herein in accordance with some embodiments.

As described above with reference to FIG. 1, the consortium of parties who are interested in the viewing metrics, e.g., the parties 110 in FIG. 1, concur on the conditions enforced on the server side (e.g., the CDN 130 and/or the view agent 140 in FIG. 1) and the enforcement of the conditions enables asserting client POV. In some embodiments, the conditions are agreed upon based on different input factors, e.g., cost, availabilities of resources, region, and/or level of data accuracy, etc. Further, in some embodiments, for cost and trust, a PRNG is used for selecting the segments from different parts of the media content item, which, when downloaded, count toward the POV assertion. The PRNG value is used as the seed and agreed upon by the parties, and using the PRNG value as a seed, each member in the consortium can calculate the same pseudo random result for a respective viewing session to ensure data integrity.

For example, the conditions can be to require POV based on downloading all segments of a media content item. In some embodiments, the conditions can be to require POV based on downloading a percentage of segments. For example, in FIG. 4A, an exemplary media content item includes segment 1, segment 2, segment 3, segment 4, segment 5, . . . , segment 98, segment 99, and segment 100. Using the PRNG, a random value 5% is generated and specified in contract A for POV of the media content item by a client, e.g., requiring 5% of the segments to be selected and reported as POV. Upon receiving the reporting of segments 1 through 5 (e.g., 5% of the 100 segments) being downloaded by the client from the view agent 140 (FIG. 1), contract A locates intent object A corresponding to the viewing of the media content item by the client and updates the state to “completed”.

In another example, in FIG. 4B, using the PRNG, random values 10%, 87%, and 3% are generated and specified as part of the conditions in contract B for POV of the media content item by a client. According to the random values specified in contract B, the content duration is split between the first 10%, followed by the next 87%, and then the last 10%. For each duration, one or more segments are randomly selected that count toward POV, e.g., selecting segment 2 in the first 10% duration, selecting segment 51 in the middle 87%, and selecting segment 98 in the last 10%. Upon receiving the reporting of segments 2, 51, and 98 being downloaded by the client from the view agent 140 (FIG. 1), contract B locates intent object B corresponding to the viewing of the media content item by the client and updates the state to “completed”.

In yet another example, using the PRNG, one or more random values, e.g., 49 and 50 in the example shown in FIG. 4C, is generated and specified as part of the conditions in contract C for POV of the media content item by a client. According to the random value(s) that correspond to the segment filename(s), segment(s) are designated as the sampling for POV, e.g., segment 49 and segment 50 in the example shown in FIG. 4C. Upon receiving the reporting of segment 49 and segment 50 being downloaded by the client from the view agent 140 (FIG. 1), contract C locates intent object C corresponding to the viewing of the media content item by the client and updates the state to “completed”.

As shown in FIGS. 4A-4C, using the pseudo random value as the seed for POV conditions allows validation from multiple parties of smart contracts. Because there is a benefit of validating a transaction by multiple parties, having a full random parameter as part of the intent would make it impossible to rely on the blockchain that requires non-refutable and identical validation from multiple smart contracts, e.g., each relies on a separate random number and generates a different verification value. Also as shown in FIGS. 4A-4C, using the pseudo random value is valuable to reduce the number of blockchain transactions since not each segment is required to be reported to the blockchain 120. Using the pseudo random value, the CDN and/or view agent can determine (e.g., via the intent object) exactly the segments that require reporting and the segments that can be skipped for reporting purposes. As such, the examples shown in FIGS. 4A-4C are illustrative but not exhaustive of using the pseudo random value to enable reporting a subset of segments and trusted confidence of the reported POV data.

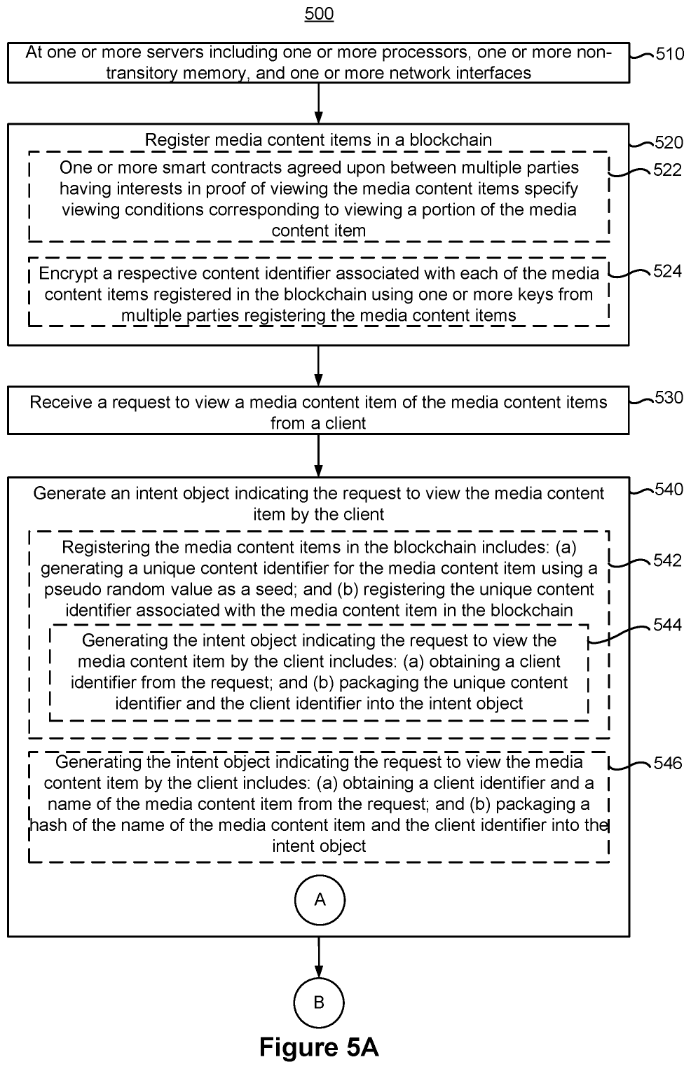

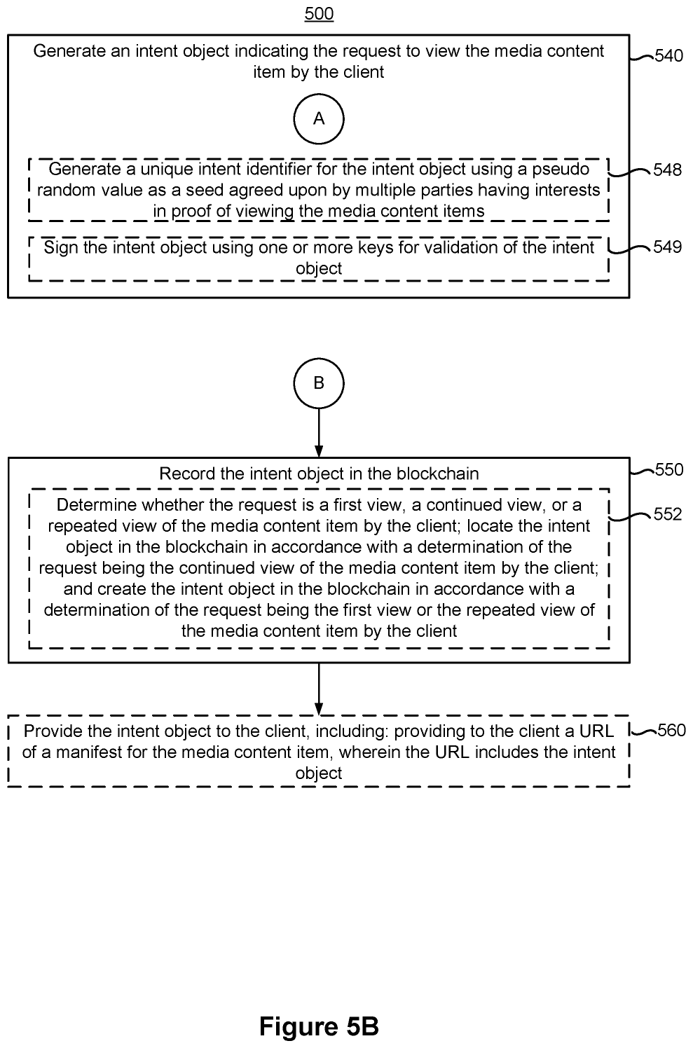

FIGS. 5A and 5B are flow diagrams illustrating a method 500 of generating and using an intent object for POV in accordance with some embodiments. As represented by block 510 in FIG. 5A, in some embodiments, the method 500 is performed at one or more servers that include one or more processors, one or more non-transitory memory, and one or more network interfaces, e.g., the one or more servers used by the parties 110 for providing content, registering content, hosting distributed blockchain database 120, the CDN 130, and/or the view agent 140 in FIG. 1.

As represented by block 520, the method 500 begins with the one or more servers registering media content items in a blockchain, e.g., registering content in the blockchain 120 as shown in FIG. 1. In some embodiments, registering the media content items in the blockchain includes registering a smart contract agreed upon between multiple parties having interests in proof of viewing the media content items. For example, the parties 110 as shown in FIG. 1 can be a content provider and a service provider that register their content in the blockchain 120 as well as use a smart contract agreed between them. As such, once multiple parties agree on conditions specified in a smart contract, the parties can rely on the same smart contract for POV. Both the content provider and the service provider have interests in proof of viewing the registered media content items. In some embodiments, as represented by block 522, one or more smart contracts agreed upon between multiple parties having interests in proof of viewing the media content items specify viewing conditions corresponding to viewing a portion of the media content item. For example, as shown in FIGS. 4A-4C, the smart contract can specify conditions such as viewing a percentage of the segments, certain segments from certain durations, and/or designated segment(s), etc. In some embodiments, the associations between smart contracts and the sets of viewing conditions are many-to-many. For example, the service provider can associate each asset to a smart contract specifying one set of viewing conditions. In another example, once two parties agree on similar contractual validations, e.g., a percentage of view is acceptable, such viewing conditions can be used in many smart contracts between the two parties.

In some embodiments, as represented by block 524, registering the media content items in the blockchain includes encrypting a respective content identifier associated with each of the media content items registered in the blockchain using one or more keys from multiple parties registering the media content items. As such, in the blockchain database 120 in FIG. 1, there is a potential entry with a unique content identifier for content that is accessible with the keys of the parties 110 such as content providers and service providers.

The method 500 continues, as represented by block 530, with the one or more servers receiving a request to view a media content item of the media content items from a client. For example, in step 1 of FIG. 2, a server for the service provider 210 receives a request from the client device 150 indicating the intent of the client at the client device 150 to view the media content item, where the request includes the content name (and/or other content identifier) and the client ID. As represented by block 540, the method 500 continues with the one or more servers generating an intent object indicating the request to view the media content item by the client. For example, in step 2 of FIG. 2, in response to the request in step 1, the server for the service provider 210 generates the intent object representing the intent of the client at the client device 150 viewing the media content item.

In some embodiments, as represented by block 542, registering the media content items in the blockchain includes: (a) generating a unique content identifier for the media content item using a pseudo random value as a seed; and (b) registering the unique content identifier associated with the media content item in the blockchain. In such embodiments, as represented by block 544, generating the intent object indicating the request to view the media content item by the client includes: (a) obtaining a client identifier from the request; and (b) packaging the unique content identifier and the client identifier into the intent object. In some embodiments, as represented by block 546, generating the intent object indicating the request to view the media content item by the client includes: (a) obtaining a client identifier and a name of the media content item from the request; and (b) packaging a hash of the name of the media content item and the client identifier into the intent object.

For example, in FIG. 1, when registering the content, the parties 110 use a PRNG value as the seed to obtain the unique content identifiers, so that the parties 110 agreeing to the smart contracts for POV of the content can validate the viewing of the content independently. Further, the unique content identifiers obtained from registering the content in the blockchain 120 in FIG. 1 is then packaged into the intent object by the server of the service provider 210 in step 2 of FIG. 2. Also as shown in FIG. 2, when generating the intent object in step 2, in some embodiments, the server for the service provider 210 obtains the content name and the client ID from the request and packages a hash value of the content name and the client ID into the intent object.

Turning to FIG. 5B, as represented by block 548, in some embodiments, generating the intent object indicating the request to view the media content item by the client includes generating a unique intent identifier for the intent object using a pseudo random value as a seed agreed upon by multiple parties having interests in proof of viewing the media content items. As such, the system described herein uses one or more pseudo random number generators for various embodiments, e.g., for generating the unique intent identifier so that multiple parties can locate the same intent object, for the segment selection to count towards POV, and/or for generating the unique content identifiers that parties agreed upon, etc.

As represented by block 549, in some embodiments, generating the intent object indicating the request to view the media content item includes signing the intent object using one or more keys for validation of the intent object, e.g., using key(s) from multiple parties having interests in proof-of-viewing the media content item or using key(s) regardless of the parties. For example, the intent object can be a string, and the server signs the intent string before sending the signed intent string to the client. At playback, e.g., when the client passes the intent string to the server, the server can validate the intent string has not been modified. As such, the signing enables the server to validate that the intent object is valid and refers to the correct content.

Turning to FIG. 5B, as represented by block 550, the method 500 continues with the one or more servers recording the intent object in the blockchain. In some embodiments, as represented by block 552, recording the intent object in the blockchain includes: determining whether the request is a first view, a continued view, or a repeated view of the media content item by the client; locating the intent object in the blockchain in accordance with a determination of the request being the continued view of the media content item by the client; and creating the intent object in the blockchain in accordance with a determination of the request being the first view or the repeated view of the media content item by the client.

For example, in step 3a of FIG. 2, the service provider 210 registers the intent object on the blockchain 120 and sets its state in step 4. Also as shown in step 4 of FIG. 2, in the case of a first view of the media content item or a repeat view by the client, upon creating the new intent object in the blockchain 120, the state associated with the intent object in the blockchain 120 is set to “started”. On the other hand, as shown in FIG. 3, in the case of a continued view, e.g., reporting viewing segments of the media content item, the intent object in the blockchain 120 is located and the state associated with the intent object can be updated depending on whether the conditions specified in the smart contract are satisfied, e.g., updating the state to “completed”.

In some embodiments, as represented by block 560, the method 500 further includes providing the intent object to the client, including providing to the client a URL of a manifest for the media content item, wherein the URL includes the intent object. For example, in step 3b of FIG. 2, the service provider sends the intent object to the client device 150, e.g., embedding an intent string in the URL of the top-level manifest. Once the client device 150 obtains the intent object, subsequent requests, such as the ones shown in FIG. 3 from the client device 150 during playback, include the manifest string, which further includes the intent object.

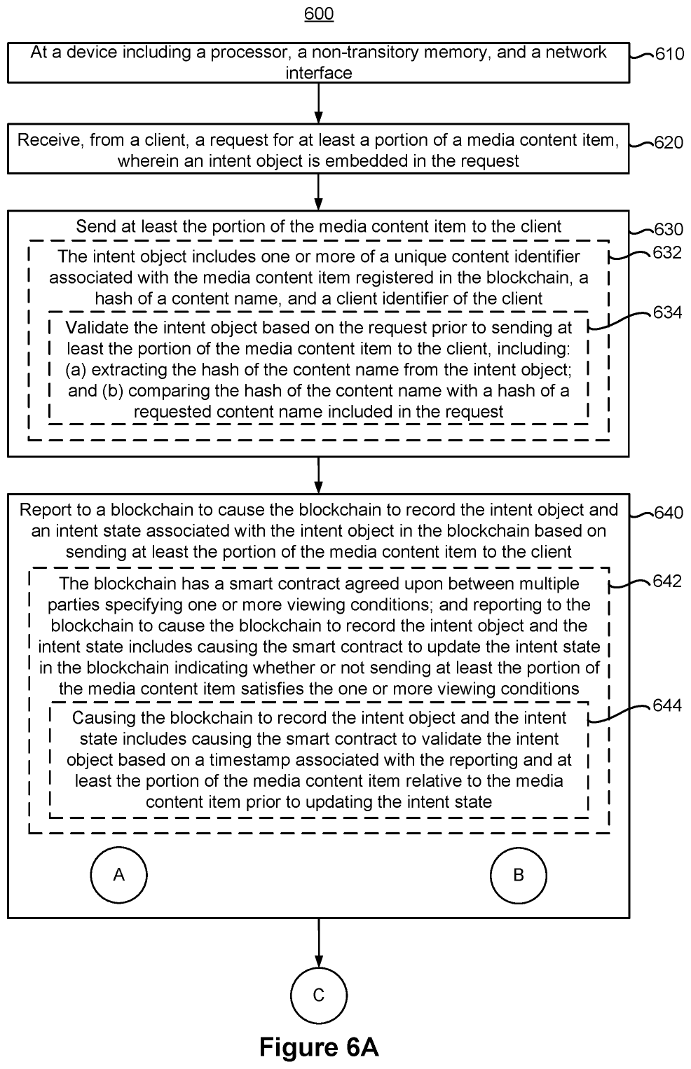

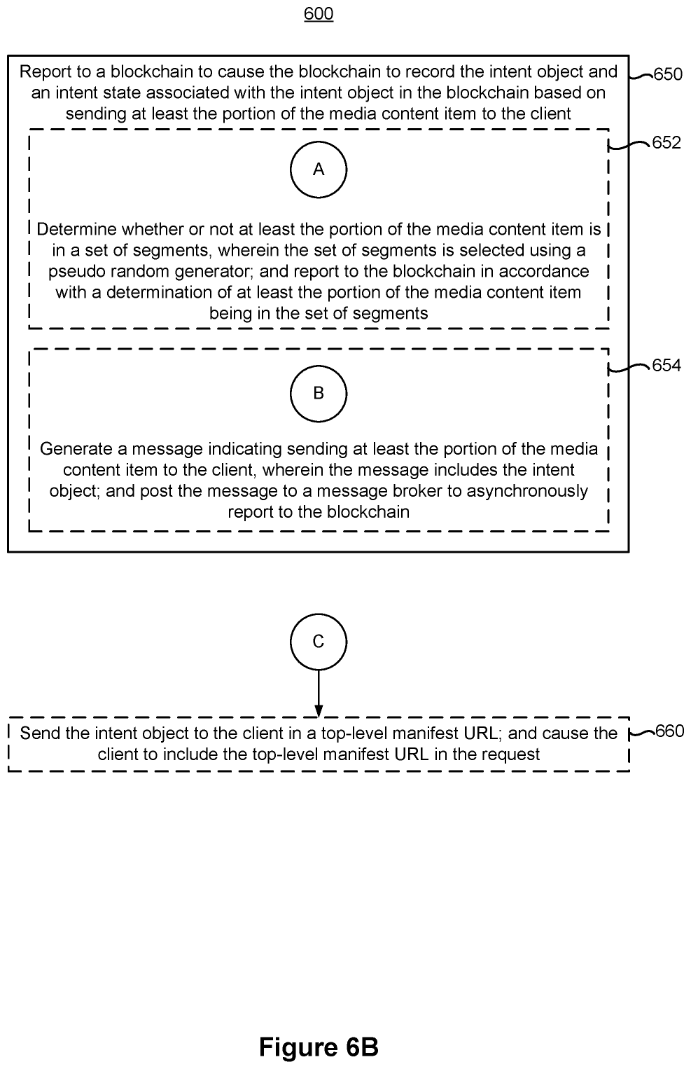

FIGS. 6A and 6B are flow diagrams illustrating a method 600 of using an intent object for POV reporting in accordance with some embodiments. As represented by block 610 in FIG. 6A, in some embodiments, the method 600 is performed at a device that includes a processor, a non-transitory memory, and a network interface, e.g., a server such as the CDN 130 and/or the view agent 140 in FIG. 1. The method 600 begins with the server receiving, from a client, a request for at least a portion of a media content item, where an intent object is embedded in the request as represented by block 620. The method 600 continues with the server sending at least the portion of the media content item to the client as represented by block 630.

In some embodiments, as represented by block 632, the intent object includes one or more of a unique content identifier associated with the media content item registered in the blockchain, a hash of a content name, and a client identifier of the client. In such embodiments, as represented by block 634, sending at least the portion of the media content item to the client includes validating the intent object based on the request prior to sending at least the portion of the media content item to the client, including extracting the hash of the content name from the intent object, and comparing the hash of the content name with a hash of a requested content name included in the request in accordance with some embodiments. For example, in step 2 of FIG. 2, the intent object generated by the server of the service provider 210 includes the unique content identifier registered in the blockchain 120, a hash value of the content name, and the client ID associated with the client device 150. As shown in FIG. 3, in step 2, the CDN 130 validates the intent object based on the request information received in step 1, e.g., by obtaining the content name from the request and comparing a hash value of the content name with the hash value of the content name extracted from the intent object. In some embodiments, in the case of the intent object being encrypted, the CDN decrypts the intent object in order to extract the hash value of the content name for validation. Also as shown in FIG. 3, once the validation passes, the CDN 130 sends the content to the client device 150 in step 3a.

The method 600 continues, as represented by block 640, with the server reporting to a blockchain to cause the blockchain to record an intent state associated with the intent object in the blockchain based on sending at least the portion of the media content item to the client. For example, in step 3b of FIG. 3, the view agent 140 reports to the blockchain, which causes the blockchain to locate the intent object and possibly update the intent state, e.g., setting the intent state to “completed” to indicate the media content item has been viewed by the client.

In some embodiments, as represented by block 642, the blockchain has a smart contract agreed upon between multiple parties specifying one or more viewing conditions. In such embodiments, reporting to the blockchain to cause the blockchain to record the intent object and the intent state includes causing the smart contract to update the intent state in the blockchain indicating whether or not sending at least the portion of the media content item satisfies the one or more viewing conditions. In such embodiments, as represented by block 644, causing the blockchain to record the intent object and the intent state includes causing the smart contract to validate the intent object based on a timestamp associated with the reporting and at least the portion of the media content item relative to the media content item prior to updating the intent state in accordance with some embodiments.

For example, the view agent 140 in FIGS. 1 and 3 has the task of updating the block chain 120 with the intent state of the viewing. The smart contract has rights to access the intent object in the blockchain 120 and can update the intent state of the intent object. Further, as shown in FIGS. 4A-4C, when the agreed-upon conditions specified in the smart contract have been met, e.g., receiving the reporting of sending 5% of the segments as shown in FIG. 4A, receiving the reporting of sending one segment in each of the 10%, 87%, and 3% of the duration as shown in FIG. 4B, or receiving the reporting of sending particular segments as shown in FIG. 4C, the smart contract updates the intent state of the intent object to “completed” as shown in step 5 of FIG. 3. In another example, as described with reference to FIG. 4C, upon receiving the reporting that certain segment(s) have been sent, the smart contract can also determine that the reporting time of view of each segment is logical based on the segment positions and/or segment durations, e.g., reject reporting of segment 50 if it is located after multiple minutes of segment 49 but segment 50 is reported only a few seconds after segment 49 is reported.

Turning to FIG. 6B, in some embodiments, as represented by block 652, reporting to the blockchain to cause the blockchain to record the intent object and the intent state includes: determining whether or not at least the portion of the media content item is in a set of segments, wherein the set of segments is selected using a pseudo random generator; and reporting to the blockchain in accordance with a determination of at least the portion of the media content item being in the set of segments. For example, as shown in FIGS. 4A-4C, once the consortium of parties, who are interested in the viewing metrics, concur on the conditions for asserting POV, the agreed-upon portion selections can be enforced in the CDN server using an agreed-upon PRNG seed, e.g., using the PRNG seed to enforce the reporting of segments 1 through 5 as shown in FIG. 4A, using the PRNG seed to enforce the reporting of segments 2, 51, and 98 as shown in FIG. 4B, or using the PRNG seed to reporting segments 49 and 50 as shown in FIG. 4C. This allows a portion of actual downloaded segments to be reported and act as the POV, thereby reducing the number of actual transactions executed in the blockchain.

In some embodiments, as represented by block 654, reporting to the blockchain includes: generating a message indicating sending at least the portion of the media content item to the client, wherein the message includes the intent object; and posting the message to a message broker to asynchronously report to the blockchain. As such, CDN 130 in FIGS. 1 and 3 validates the intent object in an efficient and self-contained manner and posts to any type of message broker with the details of the request for asynchronous processing by the view agent 140.

In some embodiments, as represented by block 660, the method 600 further includes sending the intent object to the client in a top-level manifest URL, and causing the client to include the top-level manifest URL in the request. For example, in step 3b of FIG. 2, the intent object can be sent to the client device 150 as an intent string embedded in a top-level manifest URL. Subsequently, when the client device 150 requests a playlist manifest or a media segment in step 1 of FIG. 3, the request is addressed relative to the top-level manifest and includes the top-level manifest string, which further includes the intent string.

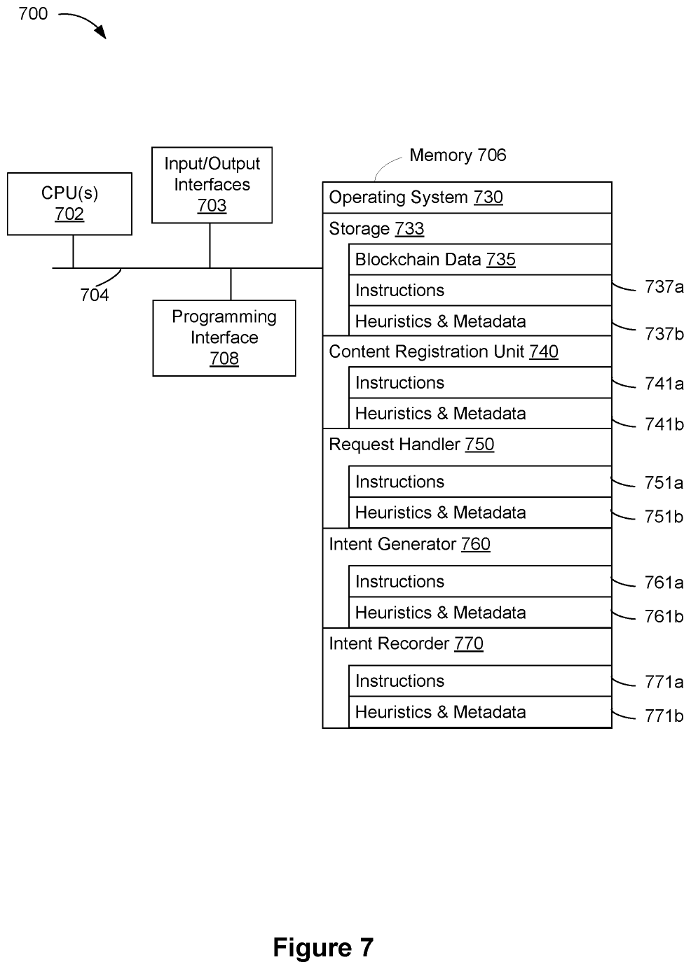

FIG. 7 is a block diagram of a computing device 700 for registering media content items in a blockchain and recording intent objects in the block for POV reporting in accordance with some embodiments. In some embodiments, the computing device 700 performs one or more functions of one or more servers used by the part(ies) 110 (FIG. 1) in the cloud, e.g., the service provider server 210 (FIG. 2), and performs one or more of the functionalities described above with respect to the server(s). While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 700 includes one or more processing units (CPUs) 702 (e.g., processors), one or more input/output interfaces 703 (e.g., input devices, sensors, a network interface, a display, etc.), a memory 706, a programming interface 708, and one or more communication buses 704 for interconnecting these and various other components.

In some embodiments, the communication buses 704 include circuitry that interconnects and controls communications between system components. The memory 706 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706 comprises a non-transitory computer readable storage medium. Moreover, in some embodiments, the memory 706 or the non-transitory computer readable storage medium of the memory 706 stores the following programs, modules and data structures, or a subset thereof including an optional operating system 730, a storage module 733, a content registration unit 740, a request handler 750, an intent generator 760, and an intent recorder 770. In some embodiments, one or more instructions are included in a combination of logic and non-transitory memory. The operating system 730 includes procedures for handling various basic system services and for performing hardware dependent tasks.

In some embodiments, the storage module 733 stores data related to media content delivery. In some embodiments, the storage 733 also stores distributed blockchain data 735, e.g., data for the blockchain 120 in FIGS. 1-3 and 4A-4C. To that end, the storage module 733 includes a set of instructions 737a and heuristics and metadata 737b.

In some embodiments, the content registration unit 740 (e.g., a unit in the server(s) used by the part(ies) 110 in FIGS. 1 and 3) is configured to register media content items as the blockchain data 735. To that end, the content registration unit 740 includes a set of instructions 741a and heuristics and metadata 741b.

In some embodiments, the request handler 750 (e.g., a unit in the server(s) used by the part(ies) 110 in FIGS. 1 and 3) is configured to receive requests for media content items and provide information related to the delivery of the media content items, e.g., URLs including intent objects, manifests, and/or segments of media content items. To that end, the request handler 750 includes a set of instructions 751a and heuristics and metadata 751b.

In some embodiments, the intent generator 760 (e.g., a unit in the server(s) used by the part(ies) 110 in FIGS. 1 and 3) is configured to generate intent objects indicating the request to view media content items. To that end, the intent generator 760 includes a set of instructions 761a and heuristics and metadata 761b.

In some embodiments, the intent recorder 770 (e.g., a unit in the server(s) used by the part(ies) 110 in FIGS. 1 and 3) is configured to record the intent objects generated by the intent generator 760 as the blockchain data 735. To that end, the intent recorder 770 includes a set of instructions 771a and heuristics and metadata 771b.

Although the storage module 733, the content registration unit 740, the request handler 750, the intent generator 760, and the intent recorder 770 are illustrated as residing on a single computing device 700, it should be understood that in other embodiments, any combination of the storage module 733, the content registration unit 740, the request handler 750, the intent generator 760, and the intent recorder 770. For example, in some embodiments, each of the storage module 733, the content registration unit 740, the request handler 750, the intent generator 760, and the intent recorder 770 resides on a separate computing device.

Moreover, FIG. 7 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

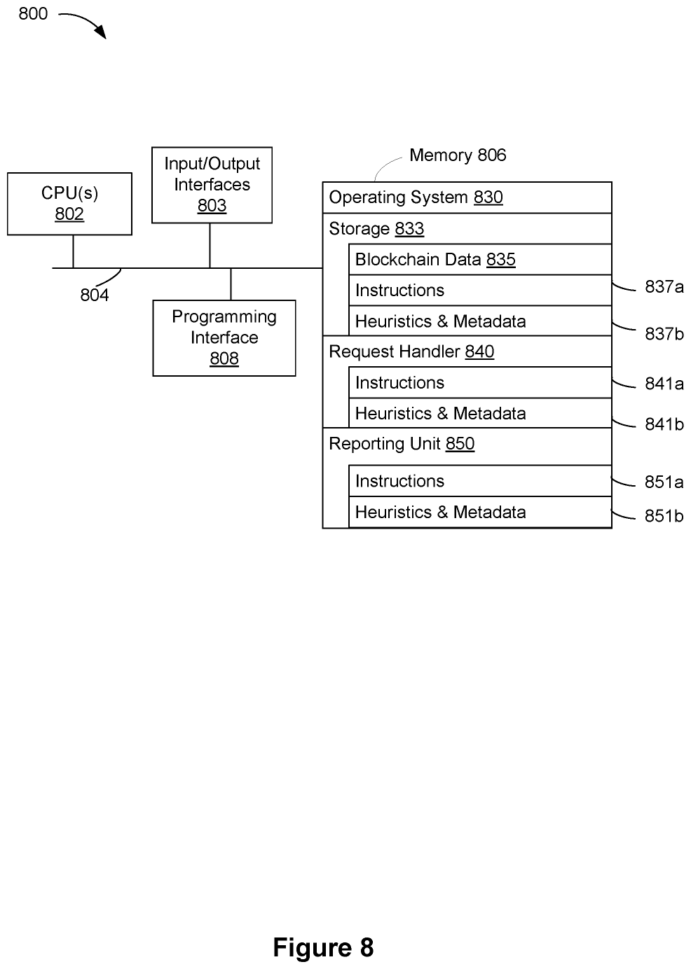

FIG. 8 is a block diagram of a computing device 800 for using intent objects recorded in a blockchain for tracking POV reporting in accordance with some embodiments. In some embodiments, the computing device 800 performs one or more functions of a device hosting the view agent 140 (FIGS. 1 and 3) and/or the CDN 130 (FIGS. 1 and 3) and performs one or more of the functionalities described above with respect to the view agent 140 and/or the CDN 130. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 800 includes one or more processing units (CPUs) 802 (e.g., processors), one or more input/output interfaces 803 (e.g., input devices, sensors, a network interface, a display, etc.), a memory 806, a programming interface 808, and one or more communication buses 804 for interconnecting these and various other components.

In some embodiments, the communication buses 804 include circuitry that interconnects and controls communications between system components. The memory 806 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 806 optionally includes one or more storage devices remotely located from the CPU(s) 802. The memory 806 comprises a non-transitory computer readable storage medium. Moreover, in some embodiments, the memory 806 or the non-transitory computer readable storage medium of the memory 806 stores the following programs, modules and data structures, or a subset thereof including an optional operating system 830, a storage module 833, a request handler 840, and a reporting unit 850. In some embodiments, one or more instructions are included in a combination of logic and non-transitory memory. The operating system 830 includes procedures for handling various basic system services and for performing hardware dependent tasks.

In some embodiments, the storage module 833 stores data related to media content delivery. In some embodiments, the storage 833 also stores distributed blockchain data 835, e.g., data for the blockchain 120 in FIGS. 1-3 and 4A-4C. To that end, the storage module 833 includes a set of instructions 837a and heuristics and metadata 837b.

In some embodiments, the request handler 840 (e.g., a unit in the view agent 140 and/or the CDN 130, FIGS. 1 and 3) is configured to receive requests for media content items and provide information related to the delivery of the media content items, e.g., URLs including intent objects, manifests, and/or segments of media content items. To that end, the request handler 840 includes a set of instructions 841a and heuristics and metadata 841b.

In some embodiments, the reporting unit 850 (e.g., a unit in the view agent 140 and/or the CDN 130, FIGS. 1 and 3) is configured to report intent objects to the blockchain and cause updates to the blockchain data 835. To that end, the reporting unit 850 includes a set of instructions 851a and heuristics and metadata 851b.

Although the storage module 833, the request handler 840, and the reporting unit 850 are illustrated as residing on a single computing device 800, it should be understood that in other embodiments, any combination of the storage module 833, the request handler 840, and the reporting unit 850. For example, in some embodiments, each of the storage module 833, the request handler 840, and the reporting unit 850 resides on a separate computing device.

Moreover, FIG. 8 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 8 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at one or more servers including one or more processors, one or more non-transitory memory, and one or more network interfaces:
registering media content items in a blockchain;
receiving a request to view a media content item of the media content items from a client;
generating an intent object indicating the request to view the media content item by the client; and
recording the intent object in the blockchain.

2. The method of claim 1, wherein:
one or more smart contracts agreed upon between multiple parties having interests in proof of viewing the media content items specify viewing conditions corresponding to viewing a portion of the media content item.

3. The method of claim 1, wherein registering the media content items in the blockchain includes:
encrypting a respective content identifier associated with each of the media content items registered in the blockchain using one or more keys from multiple parties registering the media content items.

4. The method of claim 1, wherein registering the media content items in the blockchain includes:
generating a unique content identifier for the media content item using a pseudo random value as a seed; and
registering the unique content identifier associated with the media content item in the blockchain.

5. The method of claim 4, wherein generating the intent object indicating the request to view the media content item by the client includes:
obtaining a client identifier from the request; and
packaging the unique content identifier and the client identifier into the intent object.

6. The method of claim 1, wherein generating the intent object indicating the request to view the media content item by the client includes:
obtaining a client identifier and a name of the media content item from the request; and
packaging a hash of the name of the media content item and the client identifier into the intent object.

7. The method of claim 1, wherein generating the intent object indicating the request to view the media content item by the client includes:
generating a unique intent identifier for the intent object using a pseudo random value as a seed agreed upon by multiple parties having interests in proof of viewing the media content items.

8. The method of claim 1, wherein generating the intent object indicating the request to view the media content item includes:
signing the intent object using one or more keys for validation of the intent object.

9. The method of claim 1, wherein recording the intent object in the blockchain includes:
determining whether the request is a first view, a continued view, or a repeated view of the media content item by the client;
locating the intent object in the blockchain in accordance with a determination of the request being the continued view of the media content item by the client; and
creating the intent object in the blockchain in accordance with a determination of the request being the first view or the repeated view of the media content item by the client.

10. The method of claim 1, further comprising providing the intent object to the client, including:
providing to the client a URL of a manifest for the media content item, wherein the URL includes the intent object.

11. A method comprising:
at a device including a processor, a non-transitory memory, and a network interface:
receiving, from a client, a request for at least a portion of a media content item, wherein an intent object is embedded in the request;
sending at least the portion of the media content item to the client; and
reporting to a blockchain to cause the blockchain to record an intent state associated with the intent object in the blockchain based on sending at least the portion of the media content item to the client.

12. The method of claim 11, wherein the intent object includes one or more of a unique content identifier associated with the media content item registered in the blockchain, a hash of a content name, and a client identifier of the client.

13. The method of claim 12, wherein sending at least the portion of the media content item to the client includes validating the intent object based on the request prior to sending at least the portion of the media content item to the client, including:
extracting the hash of the content name from the intent object; and
comparing the hash of the content name with a hash of a requested content name included in the request.

14. The method of claim 11, wherein:
the blockchain has a smart contract agreed upon between multiple parties specifying one or more viewing conditions; and
reporting to the blockchain to cause the blockchain to record the intent object and the intent state includes causing the smart contract to update the intent state in the blockchain indicating whether or not sending at least the portion of the media content item satisfies the one or more viewing conditions.

15. The method of claim 14, wherein causing the blockchain to record the intent object and the intent state includes:
causing the smart contract to validate the intent object based on a timestamp associated with the reporting and at least the portion of the media content item relative to the media content item prior to updating the intent state.

16. The method of claim 11, wherein reporting to the blockchain to cause the blockchain to record the intent object and the intent state includes:
determining whether or not at least the portion of the media content item is in a set of segments, wherein the set of segments is selected using a pseudo random generator; and
reporting to the blockchain in accordance with a determination of at least the portion of the media content item being in the set of segments.

17. The method of claim 11, wherein reporting to the blockchain includes:
generating a message indicating sending at least the portion of the media content item to the client, wherein the message includes the intent object; and
posting the message to a message broker to asynchronously report to the blockchain.

18. The method of claim 11, further comprising:
sending the intent object to the client in a top-level manifest URL; and
causing the client to include the top-level manifest URL in the request.

19. A system comprising:
one or more servers including one or more processors, one or more non-transitory memory for storing one or more first programs, and one or more network interfaces, wherein the one or more first programs, which, when executed by the one or more processors, cause the one or more servers to:
register media content items in a blockchain;
receive a first request to view a media content item of the media content items from a client;
generate an intent object indicating the first request to view the media content item by the client; and
record the intent object in the blockchain; and
a device including a processor, a non-transitory memory for storing one or more second programs, and a network interface, wherein the one or more second programs, which, when executed by the processor, cause the device to:
receive, from the client, a second request for at least a portion of the media content item, wherein the intent object is embedded in the request;
send at least the portion of the media content item to the client; and
report to the blockchain to cause the blockchain to record an intent state associated with the intent object in the blockchain based on sending at least the portion of the media content item to the client.

20. The system of claim 19, wherein:
one or more smart contracts agreed upon between multiple parties having interests in proof of viewing the media content items specify viewing conditions corresponding to viewing a portion of the media content item.
